(19) United States
(12) Patent Application Publication
(10) Pub. No.: US 2015/0314818 A1
(43) Pub. Date: Nov. 5, 2015

(54) TRAILER ALIGNMENT GUIDE DEVICE

(71) Applicant: Dwight Gaston, Edmond, OK (US)

(72) Inventor: Dwight Gaston, Edmond, OK (US)

(21) Appl. No.: 14/266,427

(22) Filed: Apr. 30, 2014

(51) Int. Cl. B62D 63/08

(52) U.S. Cl. CPC B62D 63/08

(57) ABSTRACT

A trailer alignment guide device facilitates alignment of a trailer behind a vehicle when backing the trailer up. The device includes a trailer coupled to a vehicle. At least one projector is coupled to the vehicle directing a beam towards the trailer. A reflector is coupled to the trailer reflecting the beam back towards the vehicle. A receiver is coupled to the vehicle and positioned to receive the beam after the beam has been reflected by the reflector. The receiver detects a position of the beam being reflected back onto the receiver. A processor is communicatively coupled to the receiver and programmed to calculate a directional instruction for aligning the trailer behind the vehicle using the position of the beam reflected back on the receiver. A display coupled to the vehicle displays the directional instruction.

### BACKGROUND OF THE DISCLOSURE

### Field of the Disclosure

The disclosure relates to alignment devices and more particularly pertains to a new alignment device for facilitating alignment of a trailer behind a vehicle when backing the trailer up.

### SUMMARY OF THE DISCLOSURE

An embodiment of the disclosure meets the needs presented above by generally comprising a trailer coupled to a vehicle. At least one projector is coupled to the vehicle directing a beam towards the trailer. A reflector is coupled to the trailer reflecting the beam back towards the vehicle. A receiver is coupled to the vehicle and positioned to receive the beam after the beam has been reflected by the reflector. The receiver detects a position of the beam being reflected back onto the receiver. A processor is communicatively coupled to the receiver and programmed to calculate a directional instruction for aligning the trailer behind the vehicle using the position of the beam reflected back on the receiver. A display coupled to the vehicle displays the directional instruction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a trailer alignment guide device according to an embodiment of the disclosure.

FIG. 2 is a side view of an embodiment of the disclosure.

FIG. 3 is a front view of a display of an embodiment of the disclosure.

FIG. 4 is a schematic view of an embodiment of the disclosure.

### DESCRIPTION OF THE PREFERRED EMBODIMENT

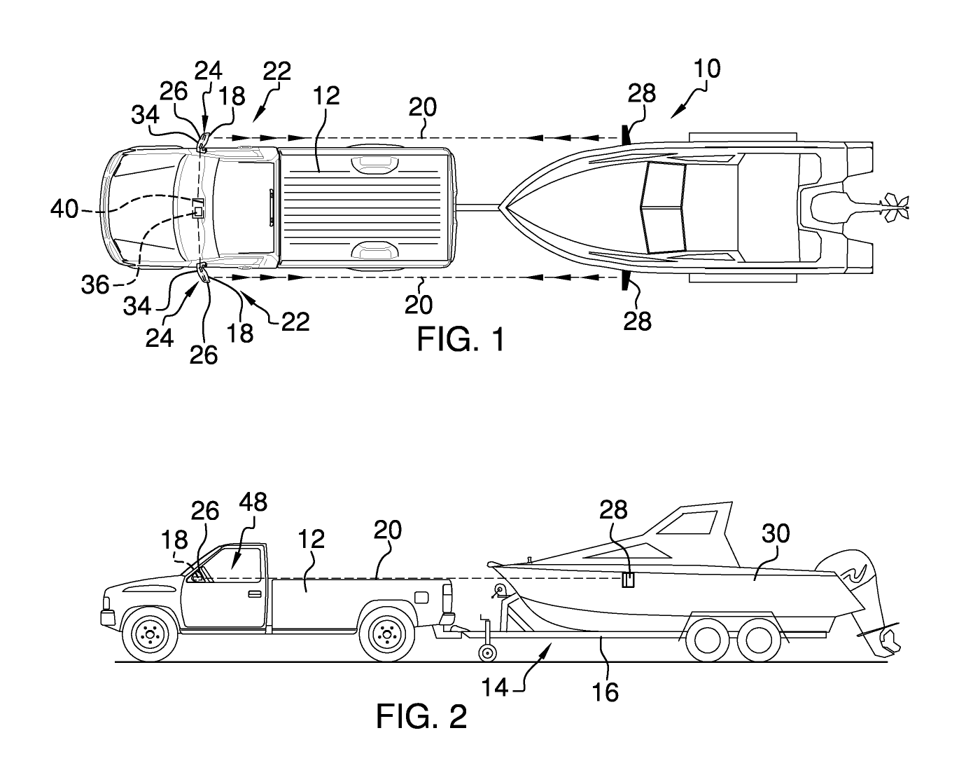

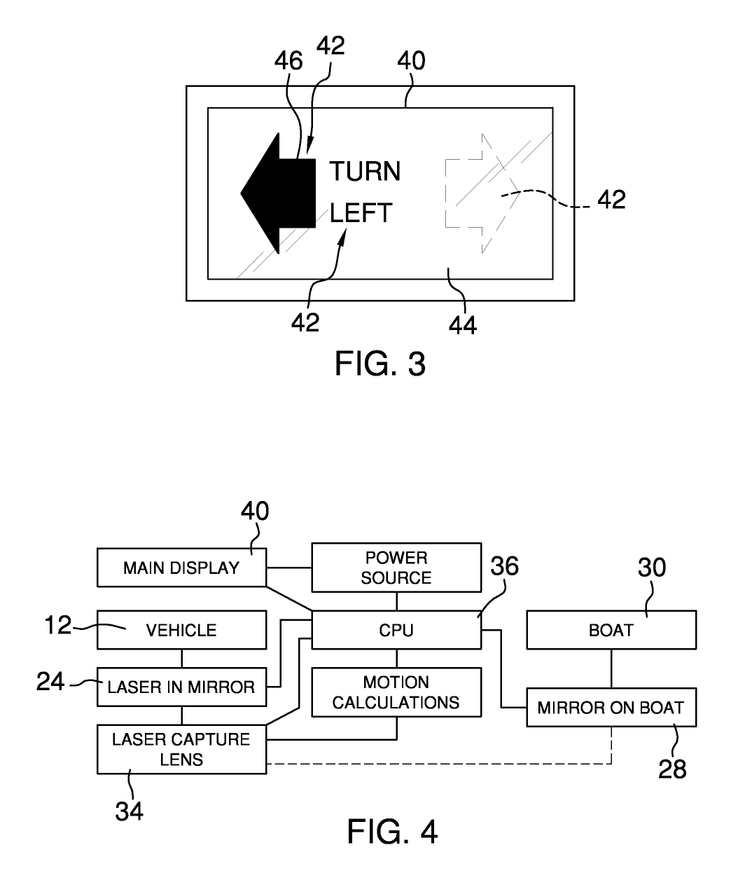

With reference now to the drawings, and in particular to FIGS. 1 through 4 thereof, a new alignment device embodying the principles and concepts of an embodiment of the disclosure and generally designated by the reference numeral 10 will be described.

As best illustrated in FIGS. 1 through 4, the trailer alignment guide device 10 generally comprises a vehicle 12 and a trailer 14 coupled to the vehicle 12. The trailer 14 may be a boat trailer 16 as the device 10 is particularly used for maintaining alignment of the trailer 14 relative to the vehicle 12 as the vehicle 12 is driven in reverse down a boat launch ramp or the like. Each of a pair of projectors 18 is coupled to the vehicle 12. Each projector 18 directs a respective beam 20 rearwardly relative to the vehicle and towards the trailer 14. Each projector 18 is positioned on an associated side 22 of the vehicle 12. Each projector 18 may be a laser 24 incorporated into a respective side minor 26 of the vehicle 12. Each of a pair of reflectors 28 is coupled to the trailer 14 rearwardly of the vehicle 12. Each reflector may be a mirror or the like. Each reflector 28 is positioned for reflecting a respective one of the beams 20 back towards the vehicle 12. Each of the reflectors 28 may be configured for coupling to a boat 30 positioned on the trailer 14 wherein each reflector 28 is coupled to the trailer 14 when the boat 30 is positioned on the trailer 14. Each of a pair of receivers 34 is coupled to the vehicle 12 and positioned to receive an associated one of the beams 20 after the associated one of the beams 20 has been reflected by the respective one of the reflectors 28. Each receiver 34 may also be incorporated into an associated one of the side mirrors 26 of the vehicle 12. Each receiver 34 detects a position of the associated one of the beams 20 when the beam 20 is reflected back onto the receiver 34. This may be detected in a conventional manner and the relative position of the beam 20 coming back is compared to a position corresponding to an aligned position defined as the position to which the beam 20 would be reflected when the trailer 14 is aligned with the vehicle 12. A processor 36 is communicatively coupled to each receiver 34 to receive positional data relevant to the beams 20. When the trailer 14 is not aligned with the vehicle 12, the processor 36 is programmed to calculate a directional instruction for aligning the trailer 14 behind the vehicle 12. The directional instruction is computed by the processor 36 using the position of each beam 20 when the respective beam 20 is reflected back on the associated receiver 34. The processor 36 is communicatively and operationally coupled to a display 40 such that the display 40 displays the directional instruction on the display 40. The display 40 may include indicia 42 which is either coupled to the display 40 and illuminated or is generated and displayed on a screen 44. The indicia 42 may be an arrow 46 directed to a particular side of the vehicle 12 towards which a driver would need to turn, accounting for traveling in reverse, to realign the vehicle 12 with the trailer 14. The display 40 is positioned in a cabin 48 of the vehicle 12 wherein the display 40 is configured for being viewed easily by the driver of the vehicle 12.

In use, the device 10 assists a person who is not adept at driving a trailered vehicle in reverse to maintain proper alignment of the vehicle 12 and the trailer 14 while driving in reverse. Thus, the device 10 facilitates launching of the boat 30 from the trailer 14 by two persons even when only one of the persons knows how to drive a boat and maintain alignment of the trailer 14 and vehicle 12 while driving in reverse. The relatively skilled person may establish initial alignment of the trailer 14 and vehicle 12 then board the boat 30. The second person may reverse the vehicle 12 down a boat launch ramp with the assistance of the device 10 to maintain proper alignment. After the first person has driven the boat 30 from the trailer 14, the second person may drive in a forward direction to remove the trailer 14 and vehicle 12 from the boat launch ramp.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A trailer alignment guide device comprising:
a vehicle;
a trailer coupled to said vehicle;
a projector coupled to said vehicle, said projector directing a beam towards said trailer;
a reflector coupled to said trailer, said reflector reflecting said beam back towards said vehicle;
a receiver coupled to said vehicle, said receiver being positioned to receive said beam after said beam has been reflected by said reflector, said receiver detecting a position of said beam reflected back onto said receiver;
a display coupled to said vehicle; and
a processor communicatively coupled to said receiver, said processor being programmed to calculate a directional instruction for aligning said trailer behind said vehicle using said position of said beam reflected back on said receiver, said processor being communicatively and operationally coupled to said display such that said display displays said directional instruction on said display.

2. The device of claim 1, further comprising said projector being a laser.

3. A trailer alignment guide device comprising:
a vehicle;
a trailer coupled to said vehicle;
a pair of projectors coupled to said vehicle, each said projector directing a respective beam towards said trailer;
a pair of reflectors coupled to said trailer, each said reflector reflecting a respective one of said beams back towards said vehicle;
a pair of receivers coupled to said vehicle, each said receiver being positioned to receive an associated one of said beams after said associated one of said beams has been reflected by said respective one of said reflectors, each said receiver detecting a position of said associated one of said beams reflected back onto said receiver;
a display coupled to said vehicle; and
a processor communicatively coupled to each said receiver, said processor being programmed to calculate a directional instruction for aligning said trailer behind said vehicle using said position of each said beam reflected back on said associated receiver, said processor being communicatively and operationally coupled to said display such that said display displays said directional instruction on said display.

4. The device of claim 3, further comprising each said projector being positioned on an associated side of said vehicle.

5. The device of claim 3, further comprising said trailer being a boat trailer.

6. The device of claim 4, further comprising each said projector being a laser.

7. The device of claim 6, further comprising each said laser being incorporated into a respective side minor of said vehicle.

8. The device of claim 3, further comprising said display being positioned in a cabin of said vehicle wherein said display is configured for being viewed by a driver of said vehicle.

9. The device of claim 5, further comprising each of said reflectors being configured for coupling to a boat positioned on said trailer wherein each said reflector is coupled to said trailer when said boat is positioned on said trailer.

10. A trailer alignment guide device comprising:
a vehicle;
a trailer coupled to said vehicle, said trailer being a boat trailer;
a pair of projectors coupled to said vehicle, each said projector directing a respective beam towards said trailer, each said projector being positioned on an associated side of said vehicle, each said projector being a laser, each said laser being incorporated into a respective side mirror of said vehicle;
a pair of reflectors coupled to said trailer, each said reflector reflecting a respective one of said beams back towards said vehicle, each of said reflectors being configured for coupling to a boat positioned on said trailer wherein each said reflector is coupled to said trailer when said boat is positioned on said trailer;
a pair of receivers coupled to said vehicle, each said receiver being positioned to receive an associated one of said beams after said associated one of said beams has been reflected by said respective one of said reflectors, each said receiver detecting a position of said associated one of said beams reflected back onto said receiver;
a display coupled to said vehicle, said display being positioned in a cabin of said vehicle wherein said display is configured for being viewed by a driver of said vehicle; and
a processor communicatively coupled to each said receiver, said processor being programmed to calculate a directional instruction for aligning said trailer behind said vehicle using said position of each said beam reflected back on said associated receiver, said processor being communicatively and operationally coupled to said display such that said display displays said directional instruction on said display.
